(19) United States
(12) Patent Application Publication
(10) Pub. No.: US 2025/0140874 A1
(43) Pub. Date: May 1, 2025

(54) MACHINE LEARNING ACCELERATED IDENTIFICATION OF BIFUNCTIONAL ACTIVE SITES IN METAL-ORGANIC FRAMEWORK DERIVED METAL OXIDE HETEROSTRUCTURES FOR HIGH-PERFORMANCE METAL-AIR BATTERIES

(71) Applicant: KOREA ADVANCED INSTITUTE OF SCIENCE AND TECHNOLOGY, Daejeon (KR)

(72) Inventors: Jeung Ku KANG, Daejeon (KR); Jong Hui CHOI, Daejeon (KR); Dong Won KIM, Daejeon (KR); Abdurrahman ADHYATMA, Daejeon (KR)

(21) Appl. No.: 18/743,147

(22) Filed: Jun. 14, 2024

(30) Foreign Application Priority Data
Oct. 27, 2023 (KR) 10-2023-0145763
Feb. 29, 2024 (KR) 10-2024-0029759

(51) Int. Cl. H01M 4/90; C01G 51/00; H01M 4/86; H01M 12/08

(52) U.S. Cl. CPC H01M 4/9016; C01G 51/40; H01M 12/08; C01P 2002/72; C01P 2002/85; C01P 2004/03; C01P 2004/04; C01P 2004/61; C01P 2004/62; C01P 2004/64; C01P 2006/40; H01M 2004/8689

(57) ABSTRACT

The present disclosure relates to an air electrode for a metal-air battery including a cobalt-manganese heterostructure, a metal-air battery including the same, and a method of preparing the cobalt-manganese heterostructure. A cobalt-manganese heterostructure according to embodiments of the present disclosure exhibits excellent oxygen reduction reaction (ORR) activity and durability as well as superior oxygen evolution reaction (OER) performances including a high current density to RuO₂ OER catalysts.

### CROSS-REFERENCE TO RELATED APPLICATION

This application claims the benefit under 35 U.S.C. § 119 (a) of Korean Patent Applications No. 10-2023-0145763 filed on Oct. 27, 2023 and No. 10-2024-0029759 filed on Feb. 29, 2024 in the Korean Intellectual Property Office, the entire disclosures of which are incorporated herein by reference for all purposes.

### TECHNICAL FIELD

The present disclosure relates to an air electrode for a metal-air battery including a cobalt-manganese heterostructure, a metal-air battery including the same, and a method of preparing the cobalt-manganese heterostructure.

### BACKGROUND

Over the last few decades, the demand for electrochemical energy storage (ESS) systems and their market size have skyrocketed in a variety of applications ranging from portable devices through electric vehicles to large-scale grid systems. However, due to the safety concerns and limited energy density of currently commercialized lithium-ion batteries (LIBs), a more advanced ESS of higher energy density is required. Zn-air batteries (ZABs) have gained popularity as a solution to this problem due to their high theoretical energy density, low cost, environmental friendliness, and significantly lower fire risk. They use oxygen from the atmosphere at their air cathode, where oxygen is reduced to hydroxides via oxygen reduction reaction (ORR) during discharge, and hydroxides are oxidized to release oxygen via oxygen evolution reaction (OER) during charge. Because oxygen is drawn directly from the air, ZABs in principle could have higher gravimetric and volumetric energy densities than those of commercial LIBs. However, the slow kinetics of the four-electron transfer steps involving ORR and OER, as well as the slow oxygen mass transport, remain major challenges in realizing high power density and charge-discharge cycle stability, thus in turn preventing ZABs from fully exploiting their theoretically high energy density. Precious metal-based catalysts, such as RuO₂ for OER and Pt/C for ORR, have been shown to have good catalytic activity towards ORR and OER. However, combining different catalysts in the same cathode is extremely difficult. Furthermore, the high cost and scarcity of novel metals limit their use in practical applications.

### PRIOR ART LITERATURE

### Non-Patent Literature

Sambhaji S. Shinde, Jin Young Jung, Nayantara K. Wagh, Chi Ho Lee, Dong-Hyung Kim, Sung-Hae Kim, Sang Uck Lee, Jung-Ho Lee, “Ampere-hour-scale zinc-air pouch cells”, Nature Energy volume 6, pages 592-604 (2021)

### DISCLOSURE OF THE INVENTION

### Problems to be Solved by the Invention

The present disclosure provides an air electrode for a metal-air battery including a cobalt-manganese heterostructure, a metal-air battery including the same, and a method of preparing the cobalt-manganese heterostructure.

However, problems to be solved by the present disclosure are not limited to the above-described problems. Although not described herein, other problems to be solved by the present disclosure can be clearly understood by a person with ordinary skill in the art from the following descriptions.

### Means for Solving the Problems

A first aspect of the present disclosure provides an air electrode for a metal-air battery, including a cobalt-manganese heterostructure which contains a cobalt oxide and a manganese oxide, and an interface between the cobalt oxide and the manganese oxide contains an oxygen defect.

A second aspect of the present disclosure provides a metal-air battery including: the air electrode according to the first aspect, an anode containing a metal; and an electrolyte.

A third aspect of the present disclosure provides a method of preparing a cobalt-manganese heterostructure, including: obtaining a metal-organic framework; mixing the metal-organic framework, a cobalt precursor, a manganese precursor, and a solvent, and performing a solvothermal reaction to obtain a cobalt-manganese layered double hydroxide; and performing a thermal treatment of the cobalt-manganese layered double hydroxide to obtain the cobalt-manganese heterostructure.

### Effects of the Invention

A cobalt-manganese heterostructure according to embodiments of the present disclosure exhibits excellent oxygen reduction reaction (ORR) activity and durability as well as superior oxygen evolution reaction (OER) performances including a high current density to RuO₂ OER catalysts.

A zinc-air battery including the cobalt-manganese heterostructure according to embodiments of the present disclosure has a high power density (394.2 mW cm⁻²), a high energy density (879 Wh kg⁻¹), and a high specific capacity (803 mAh g⁻¹) and exhibits superior performances to conventional zinc-air batteries including a Pt—C catalyst.

### BRIEF DESCRIPTION OF THE DRAWINGS

FIG. 1 illustrates a synthesis procedure for a bifunctional CoO—Mn₃O₄ heterostructure (CMH), a global optimization strategy combined with machine learning force fields for identification of the CMH, and ORR and OER mechanisms in a CMH-based zinc-air battery according to an example of the present disclosure.

FIG. 2A to FIG. 2L show morphological characteristics of ZIF-67, a CoMn layered double hydroxide (LDH) and the CMH, and specifically show low and high magnification scanning electron microscope (SEM) images of dodecahedral Mn-doped ZIF-67 (FIG. 2A and FIG. 2B), a flower-like CoMn LDH (FIG. 2C and FIG. 2D), and the CMH (FIG. 2E and FIG. 2F); a transmission electron microscope (TEM) image of the CMH (FIG. 2G); a high-resolution transmission electron microscope (HRTEM) image of the CMH, a corresponding FFT pattern, and an HRTEM image of the CMH (FIG. 2H); and scanning transmission electron microscope (STEM) elemental mapping images of the CMH (FIG. 2I to FIG. 2L) according to an example of the present disclosure.

FIG. 3A to FIG. 3F show material properties of the CMH, and specifically show powder X-ray diffraction (XRD) patterns of the Co/Mn LDH (FIG. 3A) and the CMH (FIG. 3B); survey X-ray photoelectron spectroscopy (XPS) spectra of the Co/Mn LDH and the CMH (FIG. 3C); and high resolution XPS spectra of O 1s (FIG. 3D), Mn 2p (FIG. 3E), and Co 2p (FIG. 3F) according to an example of the present disclosure.

FIG. 4A to FIG. 4F show the results of analysis of electrochemical characteristics of electrocatalytic activity, and specifically show an ORR polarization curve measured by using rotating disc electrodes (RDE) at various rotation speeds (FIG. 4A); a K-L p plot at a voltage of 0.3 V to 0.55 V (vs. RHE) derived from the RDE measurement results (insert: the electron transfer number during ORR caused by the CMH) (FIG. 4B); ORR polarization curves of CoO, Co₃O₄ and the CMH (FIG. 4C); OER polarization curves of CoO, Co₃O₄, RuO₂ and the CMH (FIG. 4D); a comparison of half-wave potential and overpotential from various samples (FIG. 4E); and ORR and OER polarization curves of the CMH (FIG. 4F) according to an example of the present disclosure.

FIG. 5A to FIG. 5G show the results of evaluation of the performance of a zinc-air battery (ZAB), and specifically show an open circuit voltage (OCV) plot (insert: OCV measured with a multimeter) (FIG. 5A); a photo of an light emitting diode (LED) driven by two ZABs (FIG. 5B); a discharge polarization curve and a corresponding power density curve (FIG. 5C); a constant current charge/discharge cycling curve at a current density of 10 mA cm⁻² (FIG. 5D); rate capability tests at various current densities (FIG. 5E); a specific capacity and an energy density of a ZAB (FIG. 5F); and a power density ratio of a conventionally reported sample with respect to a noble metal catalyst (FIG. 5G) according to an example of the present disclosure.

FIG. 6A to FIG. 6F show SEM images of the flower-like Co/Mn-LDH (FIG. 6A); and corresponding elemental mapping images (FIG. 6B to FIG. 6F) according to an example of the present disclosure.

FIG. 7 shows ORR polarization curves of benchmark Pt/C and a catalyst coated membrane (CCM) at a rotation speed of 1600 rpm according to an example of the present disclosure.

FIG. 8 shows ORR polarization curves of a metal oxide single phase (CoO and Mn₃O₄), a noble metal oxide (RuO₂), and the CMH according to an example of the present disclosure.

FIG. 9A and FIG. 9B show OER polarization curves of the CMH and RuO₂ (FIG. 9A) and a comparison of η10 and η500 of the CMH and RuO₂ (FIG. 9B) according to an example of the present disclosure.

### DETAILED DESCRIPTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Throughout the whole document, the term “connected to” may be used to designate a connection or coupling of one element to another element and includes both an element being “directly connected to” another element and an element being “electronically connected to” another element via another element.

Through the whole document, the term “on” that is used to designate a position of one element with respect to another element includes both a case that the one element is adjacent to the other element and a case that any other element exists between these two elements.

Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

In the following description, exemplary embodiments of the present disclosure will be described in detail, but the present disclosure may not be limited thereto.

A first aspect of the present disclosure provides an air electrode for a metal-air battery, including a cobalt-manganese heterostructure which contains a cobalt oxide and a manganese oxide, and an interface between the cobalt oxide and the manganese oxide contains an oxygen defect.

In an embodiment of the present disclosure, the cobalt-manganese heterostructure may be flower-like.

In an embodiment of the present disclosure, the cobalt oxide may include CoO. In an embodiment of the present disclosure, the CoO may have a rock-salt crystal structure, but may not be limited thereto.

In an embodiment of the present disclosure, the manganese oxide may include Mn₃O₄. In an embodiment of the present disclosure, the Mn₃O₄ may have a tetragonal spinel crystal structure, but may not be limited thereto.

In an embodiment of the present disclosure, the Mn₃O₄ may be grown along the edge of the CoO. In an embodiment of the present disclosure, the Mn₃O₄ may be grown along the edge of the CoO to form a heterologous bond, and the heterologous bond may suppress the formation of a bulk crystal.

In an embodiment of the present disclosure, the cobalt-manganese heterostructure may have a particle size of about 10 nm to about 500 nm, about 10 nm to about 400 nm, about 10 nm to about 300 nm, about 10 nm to about 200 nm, about 10 nm to about 150 nm, about 10 nm to about 100 nm, about 10 nm to about 90 nm, about 10 nm to about 80 nm, about 10 nm to about 70 nm, about 30 nm to about 500 nm, about 30 nm to about 400 nm, about 30 nm to about 300 nm, about 30 nm to about 200 nm, about 30 nm to about 150 nm, about 30 nm to about 100 nm, about 30 nm to about 90 nm, about 30 nm to about 80 nm, about 30 nm to about 70 nm, about 50 nm to about 500 nm, about 50 nm to about 400 nm, about 50 nm to about 300 nm, about 50 nm to about 200 nm, about 50 nm to about 150 nm, about 50 nm to about 100 nm, about 50 nm to about 90 nm, about 50 nm to about 80 nm, or about 50 nm to about 70 nm, but may not be limited thereto.

In an embodiment of the present disclosure, the cobalt-manganese heterostructure may exhibit bifunctional catalytic activity for OER (oxygen evolution reaction) and ORR (oxygen reduction reaction).

In an embodiment of the present disclosure, the cobalt-manganese heterostructure may exhibit high catalytic activity for OER during charging and ORR during discharging of the battery by regulating an electron distribution at the interface between the cobalt oxide and the manganese oxide.

In an embodiment of the present disclosure, the cobalt-manganese heterostructure may have a half-wave potential value of about 0.7 V or more, about 0.77 V or more, about 0.7 V to about 0.8 V, or about 0.77 V to about 0.8 V.

In an embodiment of the present disclosure, the cobalt-manganese heterostructure may have a higher half-wave potential value than a CoO single phase and/or a Mn₃O₄ single phase, which may imply that the cobalt-manganese heterostructure has excellent ORR activity.

In an embodiment of the present disclosure, the cobalt-manganese heterostructure may have a current density value of about 500 mA cm-2 or more.

In an embodiment of the present disclosure, the cobalt-manganese heterostructure may have a higher current density value than a conventional catalyst (Pt/C) containing Pt and C, which may imply that the cobalt-manganese heterostructure has excellent ORR activity.

In an embodiment of the present disclosure, the cobalt-manganese heterostructure may have an overpotential value of about 300 mV or less, about 250 mV to about 300 mV, about 270 mV to about 300 mV, or about 290 mV to about 300 mV at a current density of about 10 mA cm⁻².

In an embodiment of the present disclosure, the cobalt-manganese heterostructure may have an overpotential value of about 540 mV or less, about 500 mV to about 540 mV, or about 520 mV to about 540 mV at a current density of about 500 mA cm⁻².

In an embodiment of the present disclosure, the cobalt-manganese heterostructure may have a remarkably lower overpotential value than a conventional RuO₂ catalyst, which may imply that the cobalt-manganese heterostructure has excellent OER activity.

In an embodiment of the present disclosure, the cobalt-manganese heterostructure may have a Tafel slope of about 212 mV/dec or less, about 150 mV/dec or less, about 100 mV/dec or less, or about 90 mV/dec or less.

In an embodiment of the present disclosure, the cobalt-manganese heterostructure may have a lower Tafel slope than the conventional RuO₂, the CoO single phase and/or the Mn₃O₄ single phase, which may imply that the cobalt-manganese heterostructure has excellent OER activity.

In an embodiment of the present disclosure, the cobalt-manganese heterostructure may have a capacitance value of about 40 mF cm⁻² or more, about 44 mF cm⁻² or more, about 40 mF cm⁻² to about 50 mF cm⁻², or about 44 mF cm⁻² to about 50 mF cm⁻².

In an embodiment of the present disclosure, the cobalt-manganese heterostructure may have a higher capacitance value than the conventional RuO₂, the CoO single phase and/or the Mn₃O₄ single phase, which may imply that the cobalt-manganese heterostructure has excellent catalytic activity.

In an embodiment of the present disclosure, a lattice oxygen oxidation mechanism (LOM) of the cobalt-manganese heterostructure may be activated by the oxygen defect. In an embodiment of the present disclosure, the LOM of the cobalt-manganese heterostructure may be activated by the oxygen defect, and the catalytic activity for OER and ORR may be enhanced.

In an embodiment of the present disclosure, the air electrode may further include a substrate. In an embodiment of the present disclosure, the substrate may be used without limitation as long as it is one of substrate conventionally used for an air electrode. For example, the substrate may be carbon paper.

A second aspect of the present disclosure provides a metal-air battery including: the air electrode according to the first aspect, an anode containing a metal; and an electrolyte.

Detailed descriptions on the second aspect of the present disclosure, which overlap with those on the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, the electrolyte may include one or more hydroxides selected from KOH, NaOH, LiOH, Ba(OH)₂, Mg(OH)₂, and Ca(OH)₂, but may not be limited thereto.

In an embodiment of the present disclosure, the electrolyte may further include a salt including Zn(CH₃CO₂)₂, but may not be limited thereto.

In an embodiment of the present disclosure, the metal-air battery may have an open circuit voltage value of about 1.4 V or more, about 1.43 V or more, or about 1.4 V to about 1.5 V.

In an embodiment of the present disclosure, the metal-air battery may have a power density value of about 390 mW cm⁻² or more, about 394 mW cm⁻² or more, about 390 mW cm⁻² to about 395 mW cm⁻², or about 394 mW cm⁻² to about 395 mW cm⁻².

In an embodiment of the present disclosure, the metal-air battery may have a higher power density value than a conventional metal-air battery including Pt/C and/or RuO₂ as a catalyst.

In an embodiment of the present disclosure, the metal-air battery may have a specific capacity value of about 800 mAh g⁻¹ or more, about 803 mAh g⁻¹ or more, about 800 mAh g⁻¹ to about 805 mAh g⁻¹, or about 803 mAh g⁻¹ to about 805 mAh g⁻¹ at a discharge current rate of about 10 mA cm⁻².

In an embodiment of the present disclosure, the metal-air battery may have an energy density value of about 875 Wh kg⁻¹ or more, about 879 Wh kg⁻¹ or more, about 880 Wh kg⁻¹ or more, or about 875 Wh kg⁻¹ to about 880 Wh kg⁻¹ at a discharge current rate of about 10 mA cm⁻².

In an embodiment of the present disclosure, the metal-air battery may have a metal utilization rate of about 97% or more, about 97.9% or more, or about 98% or more.

In an embodiment of the present disclosure, the metal-air battery may have a higher power density value, a higher specific capacity value and/or a higher energy density value than the conventional metal-air battery including Pt/C and/or RuO₂ as a catalyst.

In an embodiment of the present disclosure, the metal-air battery may have a cycle life of about 600 cycles or more, or about 600 cycles to about 700 cycles.

In an embodiment of the present disclosure, the metal-air battery includes the heterostructure of the present disclosure. Since the heterostructure exhibits excellent bifunctional catalytic activity for ORR and OER, the metal-air battery may have excellent performances.

In an embodiment of the present disclosure, the metal-air battery may be a zinc-air battery, an aluminum-air battery, a magnesium-air battery, or a lithium-air battery, but may not be limited thereto.

A third aspect of the present disclosure provides a method of preparing a cobalt-manganese heterostructure, including: obtaining a metal-organic framework; mixing the metal-organic framework, a cobalt precursor, a manganese precursor, and a solvent, and performing a solvothermal reaction to obtain a cobalt-manganese layered double hydroxide; and performing a thermal treatment of the cobalt-manganese layered double hydroxide to obtain the cobalt-manganese heterostructure.

Detailed descriptions on the third aspect of the present disclosure, which overlap with those on the first aspect of the present disclosure, are omitted hereinafter, but the descriptions of the first aspect of the present disclosure may be identically applied to the third aspect of the present disclosure, even though they are omitted hereinafter.

In an embodiment of the present disclosure, the metal-organic framework may include Mn-doped ZIF-67, but may not be limited thereto.

In an embodiment of the present disclosure, the preparation method may include: a process of preparing a first solution by mixing the cobalt precursor, the manganese precursor, and the solvent; a process of preparing a second solution by mixing an organic ligand and a solvent; a process of obtaining the metal-organic framework by mixing and reacting the first solution with the second solution; a process of obtaining the cobalt-manganese layered double hydroxide by mixing the metal-organic framework, the cobalt precursor, the manganese precursor, and the solvent, followed by a solvothermal reaction; and a process of obtaining the cobalt-manganese heterostructure through a thermal treatment of the cobalt-manganese layered double hydroxide.

In an embodiment of the present disclosure, the organic ligand may include 2-methylimidazole, but may not be limited thereto.

In an embodiment of the present disclosure, the solvent may include methanol, but may not be limited thereto.

In an embodiment of the present disclosure, the solvothermal reaction may be performed at about 100° C. to about 150° C. for about 10 hours to about 20 hours, but may not be limited thereto.

In an embodiment of the present disclosure, the solvothermal reaction may be performed at about 100° C. to about 150° C., about 100° C. to about 140° C., about 100° C. to about 130° C., about 100° C. to about 120° C., about 110° C. to about 150° C., about 110° C. to about 140° C., about 110° C. to about 130° C., about 110° C. to about 120° C., about 120° C. to about 150° C., about 120° C. to about 140° C., or about 120° C. to about 130° C. for about 10 hours to about 20 hours, about 10 hours to about 18 hours, about 10 hours to about 17 hours, about 10 hours to about 16 hours, about 12 hours to about 20 hours, about 12 hours to about 18 hours, about 12 hours to about 17 hours, about 12 hours to about 16 hours, about 14 hours to about 20 hours, about 14 hours to about 18 hours, about 14 hours to about 17 hours, or about 14 hours to about 16 hours, but may not be limited thereto.

In an embodiment of the present disclosure, the thermal treatment of the cobalt-manganese layered double hydroxide may be performed at about 700° C. to about 800° C. for about 1 hour to about 10 hours.

In an embodiment of the present disclosure, the thermal treatment of the cobalt-manganese layered double hydroxide may be performed at about 700° C. to about 800° C., about 700° C. to about 780° C., about 700° C. to about 760° C., about 700° C. to about 750° C., about 720° C. to about 800° C., about 720° C. to about 780° C., about 720° C. to about 760° C., about 720° C. to about 750° C., about 740° C. to about 800° C., about 740° C. to about 780° C., about 740° C. to about 760° C., about 740° C. to about 750° C., about 750° C. to about 800° C., about 750° C. to about 780° C., or about 750° C. to about 760° C. for about 1 hour to about 10 hours, about 1 hour to about 5 hours, about 1 hour to about 3 hours, or about 1 hour to about 2 hours.

In an embodiment of the present disclosure, the thermal treatment of the cobalt-manganese layered double hydroxide may be performed under an inert gas, e.g., an Ar gas.

Hereinafter, example embodiments are described in more detail by using Examples, but the present disclosure may not limited to the Examples.

### Example

### 1. Method

### Preparation of Mn-Doped ZIF-67 Derived Co/Mn-LDH

Mn-doped ZIF-67 was synthesized according to the following procedure. Co(No₃)₂·6H₂O (1.096 g, 3.77 mmol) and Mn(NO₃)₂·4H₂O (348 mg, 1.39 mmol) were dissolved in 30 mL methanol to prepare solution A. Simultaneously, 2.464 g of 2-methylimidazole (30 mmol) was dissolved in 30 mL methanol to prepare solution B. Then, the solutions A and B were mixed and sonicated for 15 min. After that, the purple product was collected by centrifugation. The product was dispersed in methanol 30 mL and mixed into solution A. The mixture was transferred into a Teflon-lined 100 mL stainless steel autoclave. A solvothermal reaction was taken place (120° C., 16 h). After that, the resultant product was separated and washed with methanol three times. The obtained purple product was dried under a vacuum oven overnight.

### Preparation of CMH

100 mg of different solvothermal synthesis time Co/Mn LDH was placed in a tube furnace. Then loaded powder was thermally treated at 750° C., 2 h under an Ar atmosphere at a ramping rate of 5° C. per minute. Then the sample was naturally cooled down to room temperature. The resultant samples were labeled CMH.

### Material Characterization

The powder X-ray diffraction (XRD) data were collected from a SmartLab X-ray diffractometer (Rigaku, Japan) with Cu-Kα radiation at 1200 W (40 kV, 30 mA). The data were obtained in the 20 range of 5-80° at ambient temperature. Scanning electron microscopy (SEM) was carried out on an SU8230 (Hitachi, Japan). Transmission electron microscopy images were obtained using a JEM-ARM200F instrument (JEOL, Japan) operated at 200 kV. The sample was dispersed in ethanol and then transferred to the carbon-coated copper grid. Sample loaded copper grid was dried at 60° C. in the vacuum oven. Elemental analysis was conducted via energy-dispersive X-ray microscopy. The X-ray photoelectron spectroscopy (XPS) analyses were performed using a Thermo VG Scientific K-alpha spectrometer (Thermo Scientific, USA) with Al-Kα radiation at 350 W (3 mA). Nitrogen sorption isotherm data were collected using Qudrasorp (Quantachrome). Before measurement, all the samples were degassed at 200° C. for 24 hours under a vacuum. Pore size distribution was computed using density functional theory (DFT).

### Electrochemical Measurements

The electrochemical oxygen evolution reaction (OER) and oxygen reduction reaction (ORR) measurements were conducted on a Biologic SP-300 potentiostat with an RRDE-3A constant rotation system. A standard three-electrode electrochemical cell was adopted that was composed of a rotating disk electrode (RDE, 3 mm diameter), Pt wire, and Hg/HgO electrode as working, counter electrode, and reference electrode, respectively. The working electrode was exposed to 0.1 M KOH solution to collect electrochemical data. Catalyst ink was prepared by dispersing 4 mg of catalyst and 1 mg of Ketjenblack (EC 600 JD) in a solution containing 1 mL of ethanol and 50 μl of 5 wt % Nafion solution. The mixed solution was ultrasonicated for 30 min for a homogeneous dispersion. After that, 4 μl of catalyst ink was dropped onto the rotating disk electrode surface and dried under vacuum conditions for 2 hr with a mass loading of 0.57 mg cm⁻².

All the experiments were performed under ambient conditions and all collected data were calibrated to a reversible hydrogen electrode (RHE) using the following equation, E (vs. RHE)=E (vs. Hg/HgO)+E⁰(Hg/HgO)+0.059 X pH. The electrolyte was purged with highly pure oxygen gas for at least 30 min prior to the measurements the gas continuously flew during the test. Linear sweep voltammetry (LSV) curves were obtained at a scan rate of 10 mV s⁻¹. The electrochemical active surface area (ESCA) was determined based on the double-layer capacitance (C_{dl}) which was derived from the cyclic voltammetry (CV) curves at the non-faradic region with different scan rates. The LSV curves on RDE with different rotating speeds (400, 625, 900, 1225, 1600, 2025, 2500 rpm) were obtained during the ORR test. The corresponding electron transfer number (n) was calculated based on the Koutecky-Levich (K-L) equation:

$$\frac{1}{J} = \frac{1}{{J}_{L}} + \frac{1}{{J}_{K}} = \frac{1}{B {ω}^{1 / 2}} + \frac{1}{{J}_{K}} \qquad [ Equation 1 ]$$

$$B = 0.62 {{nFC}_{0} ( {D}_{0} )}^{2 / 3} {v}^{- 1 / 6} \qquad [ Equation 2 ]$$

Where J_{L} is the diffusion-limiting current density, J_{K} is the kinetic current density, ω is the angular velocity of the disk, n is the electron transfer number, F is the Faraday constant (96,485 C mol⁻¹), D₀ is the diffusion coefficient of O₂ (1.9×10⁻⁵ cm² s⁻¹), Co is the bulk concentration of O₂ (1.2×10⁻⁶ mol cm⁻³), and v is the kinetic viscosity of the electrolyte (0.01 cm² s⁻¹). The OER measurements were conducted at a rotation speed of 1600 rpm in O₂-saturated alkaline media. The overpotential (η) of OER was calculated by η=E_{RHE}−1.23 V. LSV curves were corrected by iR compensation in 1 M KOH.

### Zn-Air Battery Performance Evaluation

A polished and washed Zn plate (250 μm thickness) was used as an anode. The catalyst ink was dropped onto a hydrophilic layer of carbon paper with PTFE coated gas-diffusion layer and used as an air electrode. The catalyst mass loading was controlled to 1 mg cm⁻². 6 M KOH mixed with 0.2 M Zn(OAC)₂ was used as an electrolyte. A Ni foam which was carefully washed with 3M HCl and distilled water was used as a backing layer next to carbon paper to collect current and support the gas diffusion layer. For comparison, 20 wt % Pt/C and RuO₂ with a mass ratio of 1:1 were used as benchmark catalysts. The specific capacity and the energy density of Zn-air battery were calculated based on the consumed Zn plate mass.

### Density Functional Theory (DFT) Calculations

In further active learning iterations for the data acquisition, we employed adversarial attack and uncertainty sampling. We adopted the adversarial loss ( [symbol] _{adv}) by Schwalbe-Koda et al.¹ and optimized the atomic position displacement (δ) to maximize the [symbol] _{adv} as rewritten by

$${max}_{δ} {ℒ}_{adv} ( X , δ ; θ ) = {max}_{δ} p ( {X}_{δ} ) {σ}_{F}^{2} ( {X}_{δ} ) \qquad [ Equation 3 ]$$

$$p ( {X}_{δ} ) = \frac{1}{Q} exp ( - \frac{\overline{Ω} ( {X}_{δ} )}{kT} ) \qquad [ Equation 4 ]$$

Here X is the atomic positions, σ_{F}² is the variance of forces, and θ refers to the neural network parameters. For the heterostructure of stoichiometric MnₓO_{y} interfaced with CoO, we used the grand potential (Ω) in estimating the p(X_{δ}), and we optimized the δ only for atoms in the buffer or search region.

### Global Optimization

We used the grand canonical genetic algorithm (GCGA)² for the global optimization of the CMH. A population size of 20 and a mutation rate of 30% were chosen for the GCGA sampling. The pool of the initial candidates was generated by displacing the Mn and O atoms randomly based on the covalent radii and pre-optimized the structure with Hookean potential and optimized with the machine learning potentials.

### 2. Results

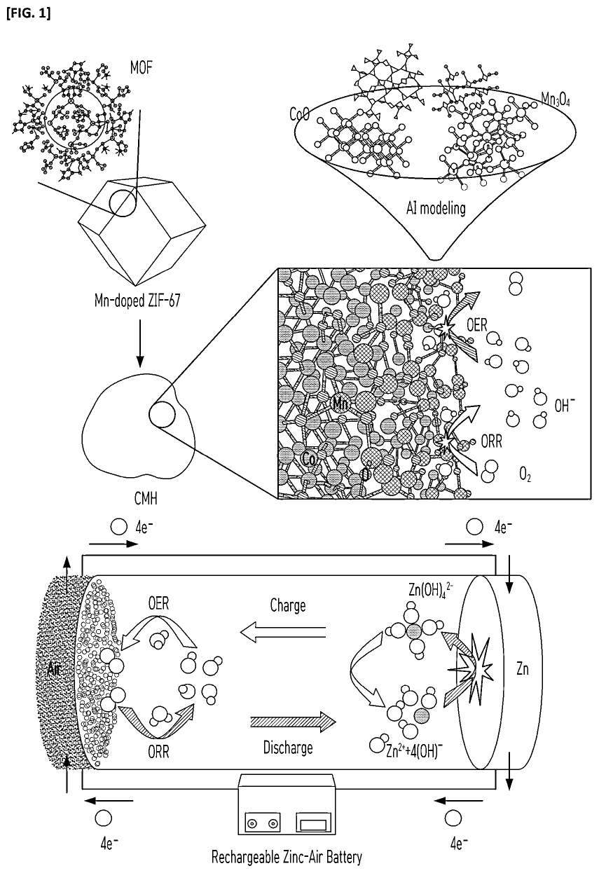

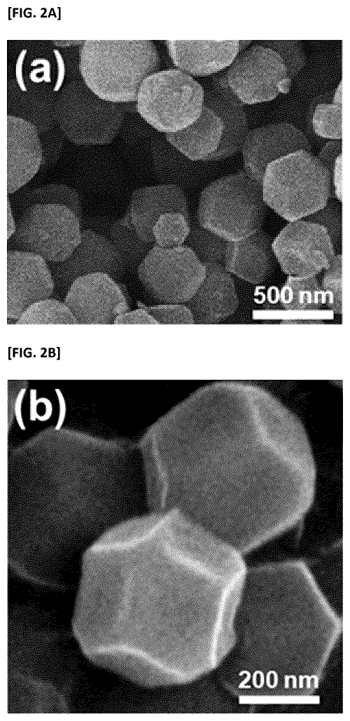

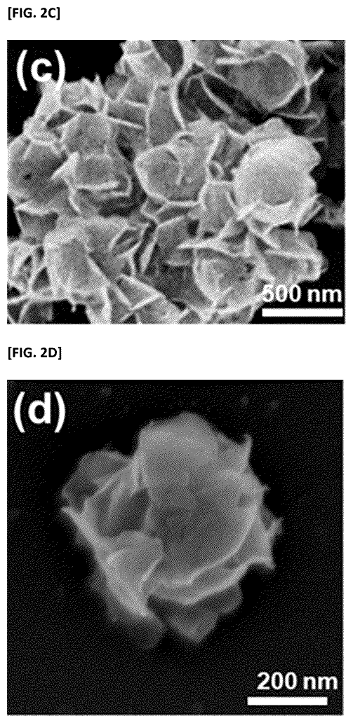

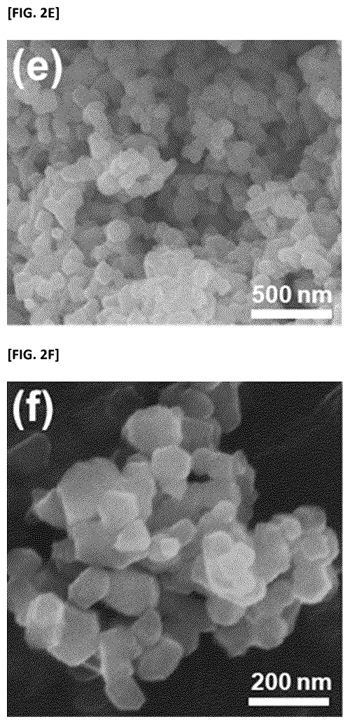

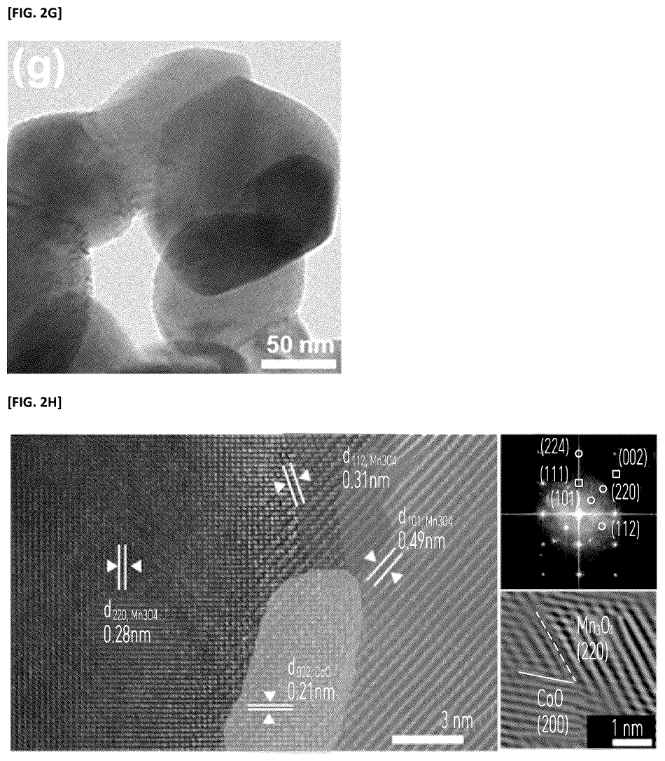

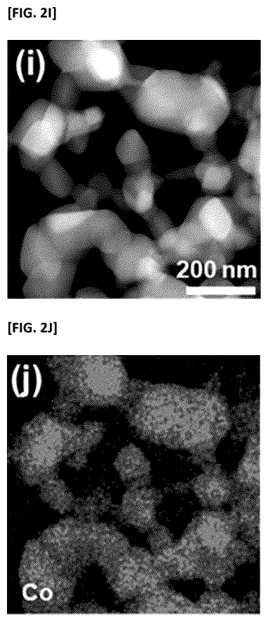

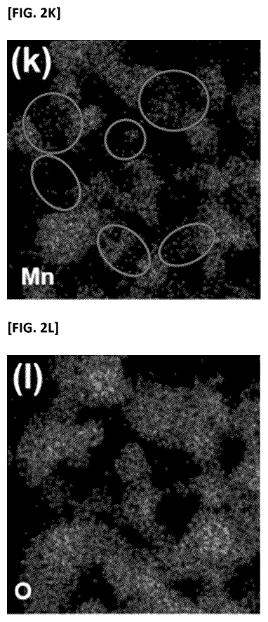

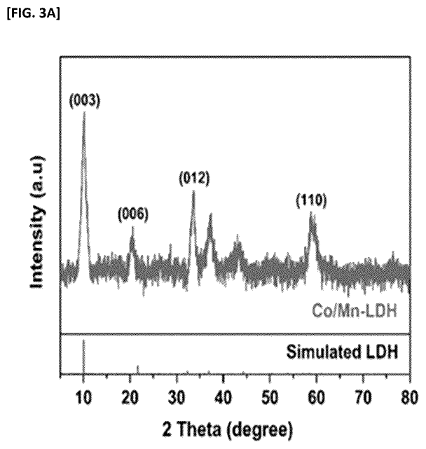

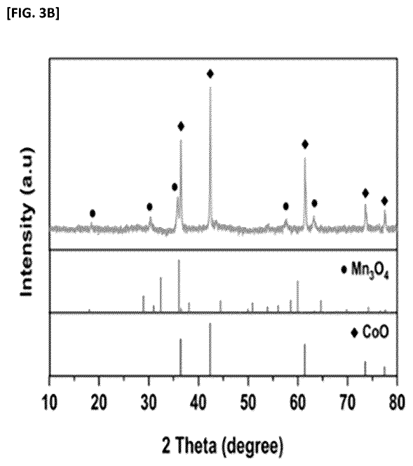

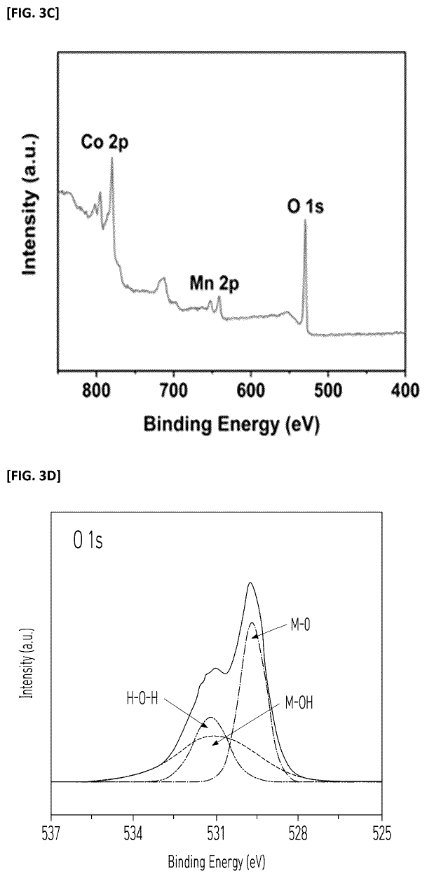

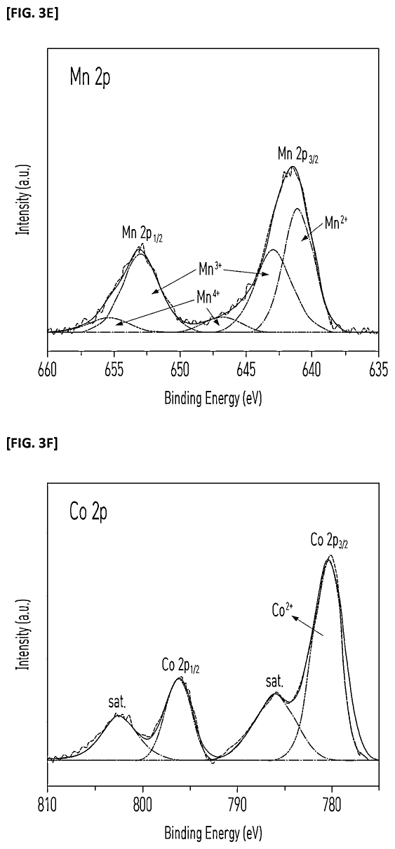

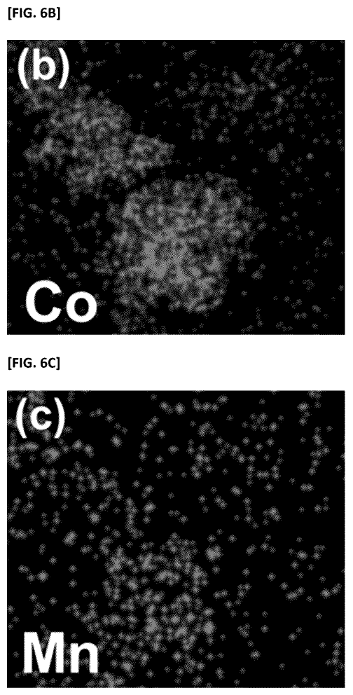

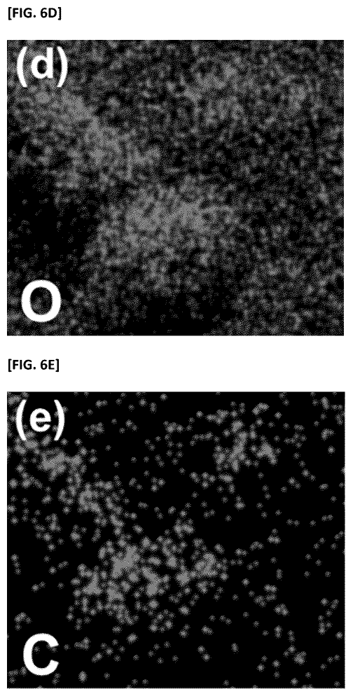

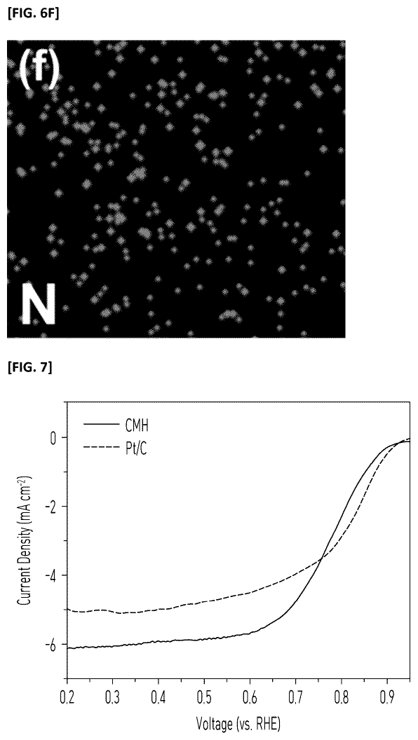

FIG. 1 depicts the synthesis procedure of CMH, which includes self-assembly, acidic etching, and annealing. Initially, Mn-doped ZIF-67 was synthesized as a template material by self-assembly of colloidal particles into well-ordered superstructures. To make Co—Mn LDH (layered double hydroxide), we mixed manganese and cobalt precursors into a dispersed Mn-doped ZIF-67 solution. During the solvothermal reaction, an acidic etching and coprecipitation process occurred. The Mn-doped ZIF-67 template was observed to be transformed into a flower-like Co—Mn LDH. After that, a thermal treatment technique was used to convert Co—Mn LDH to CMH. The X-ray diffraction (XRD) pattern of Mn-doped ZIF-67 was shown to be well-matched with the simulated peak pattern. Furthermore, as shown in FIG. 2A and FIG. 2B, Mn-doped ZIF-67 has evenly formed a characteristic dodecahedral shape with a dimension of about 400 nm. Mn (II) cation, which is in an acidic medium, was shown to be oxidized to Mn (III) during the acidic etching-based solvothermal process. To compensate for the extra positive charges caused by the substitution of Co (II) ion by Mn (III), a flower-like Co—Mn LDH (FIG. 2C and FIG. 2D) was produced, and the equivalent amounts of anions were intercalated between the edge-sharing TMO₆ (TM=Co or Mn). The XRD peaks reveal that the interlayer distance for Co—Mn LDH is about 0.89 nm (FIG. 3A). The energy dispersive X-ray spectroscopy (EDS) confirmed the presence of Co, Mn, and O species, as shown in FIG. 6A to FIG. 6F. Fine tetragonal spinel-type Mn₃O₄ and rock salt-type CoO particles were formed after annealing under Ar flow at 750° C. CMH exhibited an irregular morphology with an average diameter of about 70 nm (FIG. 2E and FIG. 2F). Moreover, we used transmission electron microscopy (TEM) to highlight the interfacial crystal growth zone between Co and Mn-based metal oxide phases (FIG. 2G to FIG. 2I). The particle was observed to have an irregular form and was about 100 nanometers (FIG. 2G). Besides, Mn₃O₄ (220) plane (0.29 nm) and CoO (200) plane (0.216 nm) were confirmed using the matching fast Fourier transform (FFT) and high-resolution TEM (HRTEM) images (FIG. 2H and FIG. 2I). Interestingly, the heterostructures were discovered between CoO (200) and Mn₃O₄ (220) planes. Furthermore, the tetragonal symmetry of Mn₃O₄ grains along the edges of Co₃O₄ can be grown due to lattice coincidence and low misfit. Mn₃O₄ grain may develop Co₃O₄ multigrain nanocrystals sequentially, and CoO is considered to be formed by the reduction of Co₃O₄ during high-temperature annealing. Additionally, the EDS spectra of CMH (FIG. 2I to FIG. 2L) confirm the existence of Co and Mn-based oxide species that are homogeneously distributed throughout the particle.

FIG. 3A and FIG. 3B reveal the X-ray diffraction (XRD) patterns of the Co/Mn LDH and CMH electrocatalyst, respectively. In addition, the elemental compositions and chemical states of electrocatalysts were investigated using X-ray photoelectron spectroscopy (XPS). Mn, Co, and O were detected in the case of CMH (FIG. 3C). Also, the O 1s spectrum can be deconvoluted into three peaks, which include one for metal-oxygen bonding (M-O), one for metal hydroxide bonding (M-OH), and one for H₂O (FIG. 3D). Mn 2p spectra exhibit the two peaks at 641.5 eV and 653.1 eV, ascribed to Mn 2p_{3/2} and Mn 2p_{1/2}, respectively, and can be split into multiple peaks (FIG. 3E). These include the peak at 641.1 eV attributed to the presence of Mn²⁺, the peaks at 643.0 eV and 653.0 eV attributed to the presence of Mn³⁺, and the peaks at 646.7 eV and 655.4 eV attributed to the presence of Mn⁴⁺. FIG. 3F presents the high-resolution spectrum of Co 2p. The two peaks at 780.5 eV and 796.3 eV correspond to Co 2p_{3/2} and Co 2p_{1/2} and can be further deconvoluted into the peaks at 780.4 eV and 796.2 eV for Co²⁺ and those at 786.0 eV and 802.4 eV for satellites. The spin-orbital splitting energy between Co 2p_{3/2} and Co 2p_{1/2} was 15.8 eV which is typical of CoO.

In addition, we constructed an atomistic model system of the CMH using grand canonical genetic algorithm (GCGA) integrated with a machine learning force field. The machine learning force field for CMH was developed using the first-principles data with the structures from uncertainty sampling, GCGA, and adversarial attack. During the GCGA, we sampled 1080 non-stoichiometric heterostructures of CMH varying Mn contents. Putative global minimum structures for each Mn content level were found and further subjected to high-accuracy relaxations. It is to be noted that the global minimum structures contain undercoordinated MnₓO_{y}. We analyzed the plane-averaged charge density difference (Δn) for representative heterostructures with Mn contents of four and six atoms. Plane-averaged charge density difference reveals the charge transfer from the MnₓO_{y} to CoO. These results are consistent with the XPS analysis that the percentage of Mn²⁺ peak decreased and Mn⁴⁺ peak increased in the case of CMH when compared to the pristine Mn₃O₄ phase.

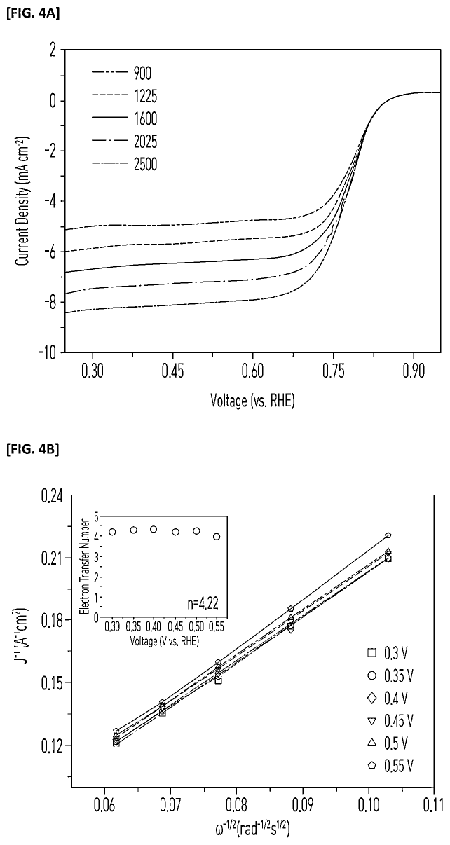

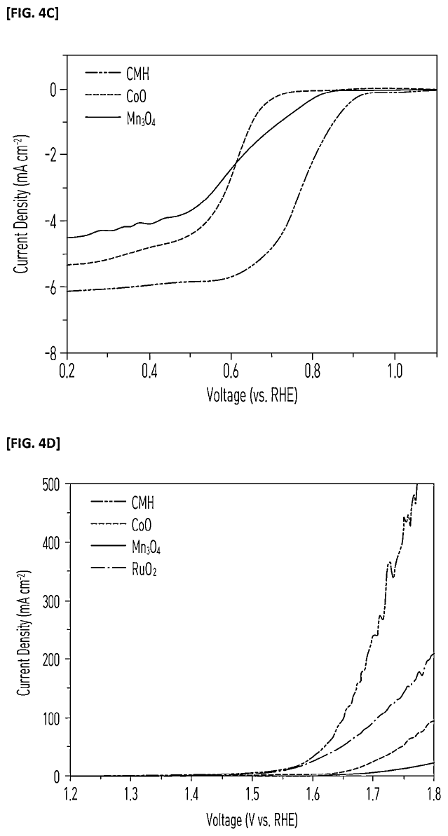

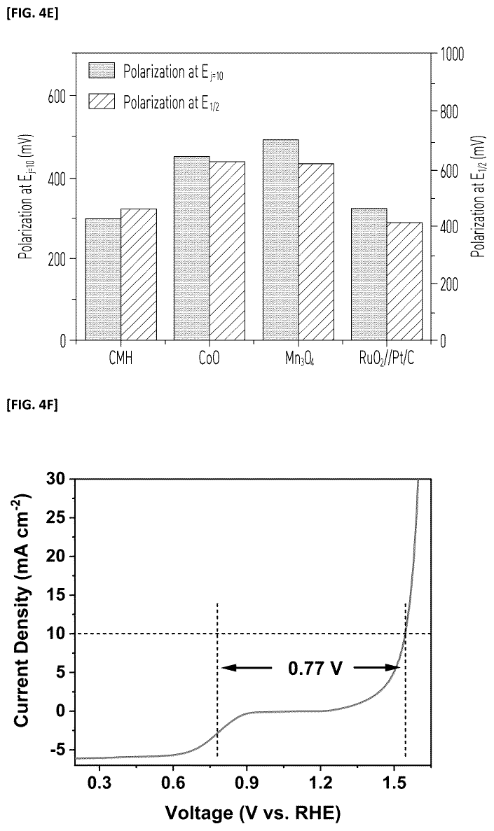

The ORR capabilities of CMH samples in 0.1 M KOH solution were investigated using a rotating disk electrode (RDE) setup. The linear scan voltammetry (LSV) responses at the RHE scale under various rotations per minute (rpm) are shown in FIG. 4A, and the corresponding Koutecky-Levich (K-L) plots are shown in FIG. 4B. The linear and parallel natures of the plots at varying voltages correspond with the first-order reaction nature of ORR, in which oxygen gas is the only limiting reactant. Furthermore, using the K-L equation (The equations 1 and 2), the electron transfer number shown by the material at varied voltages remains relatively constant at a value of 4.22, supporting that four-electron transport governs the majority of the reaction kinetics (FIG. 4B, inset). FIG. 4C shows the ORR performances for CMH, CoO, and Mn₃O₄. Individual phases (CoO and Mn₃O₄) revealed the inferior half-wave potentials of 0.6 V and 0.61 V, respectively, while CMH gave a higher half-wave potential of 0.77 V, indicating that heterostructure interfaces played to enhance ORR activity.

A small Tafel slope of 91 mV dec⁻¹ in CMH reveals the superior kinetics of ORR. As shown in FIG. 7, we compared the ORR performance of CMH with the noble metal Pt/C catalyst. The benchmark commercial Pt/C (20 wt. % Pt) catalyst exhibited an expectedly high half-wave potential of about 0.82 V, whereas CMH exhibited a comparable half-wave potential of 0.77 V. Besides, CMH exhibited a high diffusion-limiting current density value of 6.1 mA cm⁻², which is much superior to 5 mA cm⁻² of Pt/C catalyst.

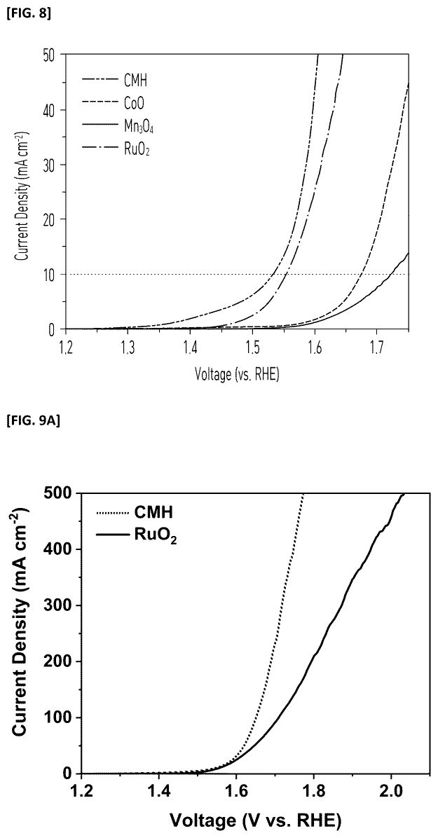

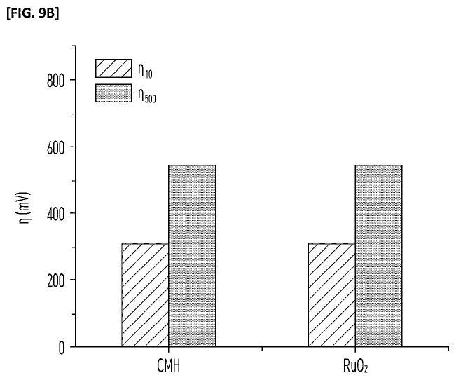

Moreover, the OER capabilities of CMH were compared to those of pristine single-phase catalysts and a commercial noble metal electrocatalyst. FIG. 8 and FIG. 4D show the LSV (linear scan voltammetry) curves of CMH, CoO, Mn₃O₄, and RuO₂ in 1 M KOH solution. CMH exhibited a remarkably low overpotential at 10 mA cm⁻² of 310 mV which outperforms the 320 mV of RuO₂ (FIG. 4E). The Tafel slope of CMH was smaller than those of CoO and Mn₃O₄, implying enhanced kinetics for the heterostructure. Also, the electrochemical double-layer capacitance (Cdi) was derived using CV curves to further analyze the reaction kinetics. CMH has the highest capacitance of 44.60 mF cm⁻² when compared to CoO (17.45 mF cm⁻²), Mn₃O₄ (13.42 cm⁻²), and RuO₂ (23.07 mF cm⁻²). The high Cal value of CMH guarantees fast reaction kinetics and effective usage of active sites. Moreover, electrochemical impedance spectroscopy (EIS) was performed to investigate charge-transfer resistance at the electrode and electrolyte interface. Nyquist plots from three different samples were obtained. The hemisphere of the CMH sample was the smallest, suggesting improved kinetics after the forming heterostructure. When the current density reaches 500 mA cm⁻², which is necessary for industrial applications, the OER performance of CMH was observed to become more noticeable. The commercial RuO₂ exhibited a much higher overpotential of 810 mV compared to the very low overpotential value of 540 mV of CMH (FIG. 9A and FIG. 9B). The OER reaction on oxides exhibits pH-dependent activity when lattice oxygen participates in the electrochemical process. Previous research has shown that the lattice oxygen oxidation mechanism (LOM) with direct O—O coupling can lead to higher catalytical activity than the conventional adsorbate evolution mechanism (AEM), which is highly correlated to the adsorption strength of multiple adsorbed intermediates. Thus, to further understand the OER mechanism, we explored the OER activity of CMH under various hydroxide ion concentrations. CMH displayed a substantial pH dependence under the given reaction conditions, confirming the role of LOM. The pH dependence could be caused by a mismatch between electron transfer kinetics and hydroxide affinity at the interface of oxide/electrolyte. Furthermore, the OER stability of the CMH electrocatalyst was established. After repeated 2000 cycles, a negligible 10 mV of activity loss was measured, showing that catalytic resilience for practical use is secured. The chronopotentiometric analysis further confirmed the great stability. The voltage gap of 0.77 V between the overpotential at 10 mA cm⁻² for OER and the half-wave potential for ORR in FIG. 4F indicates that it can operate as a low-cost bifunctional ORR/OER catalyst for high-performance ZABs. We next used density functional theory calculations to investigate the bifunctional activity of CMH and underlying mechanisms.

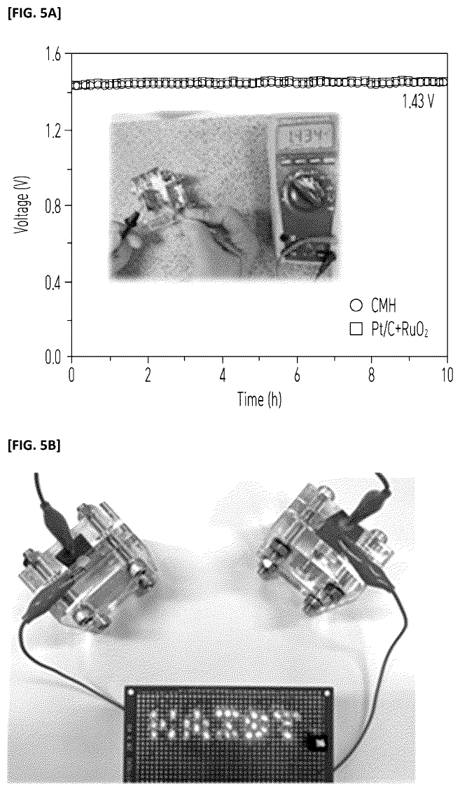

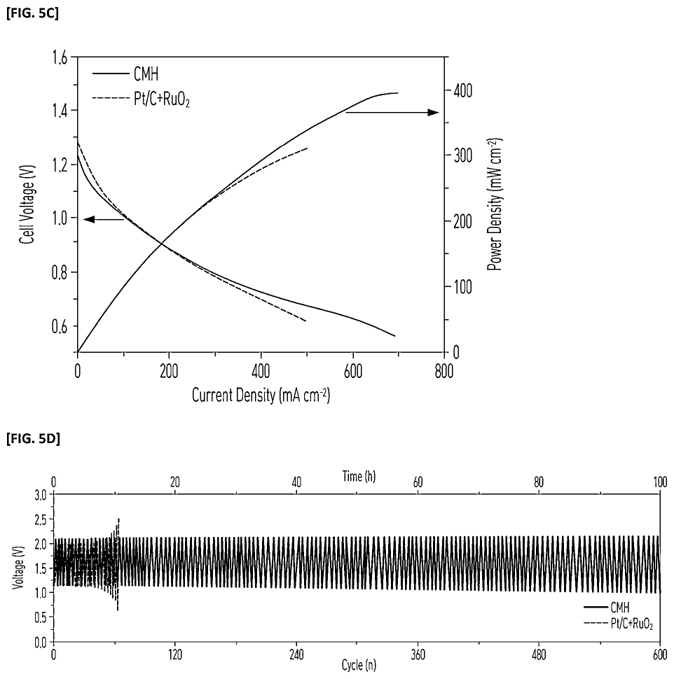

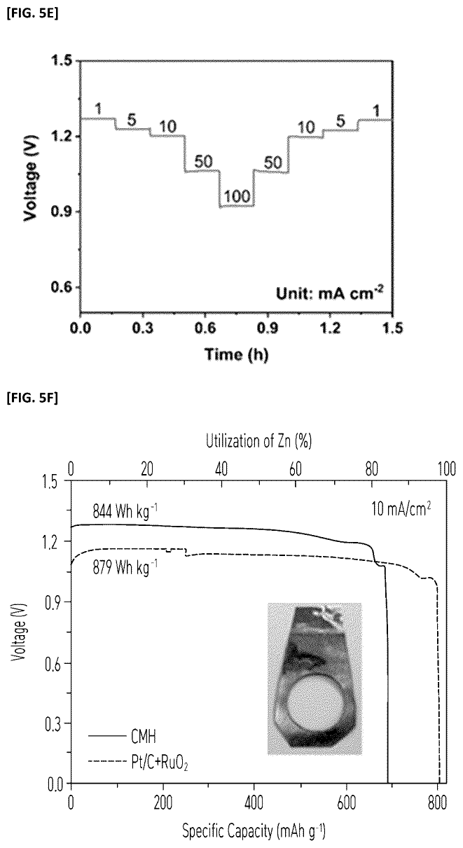

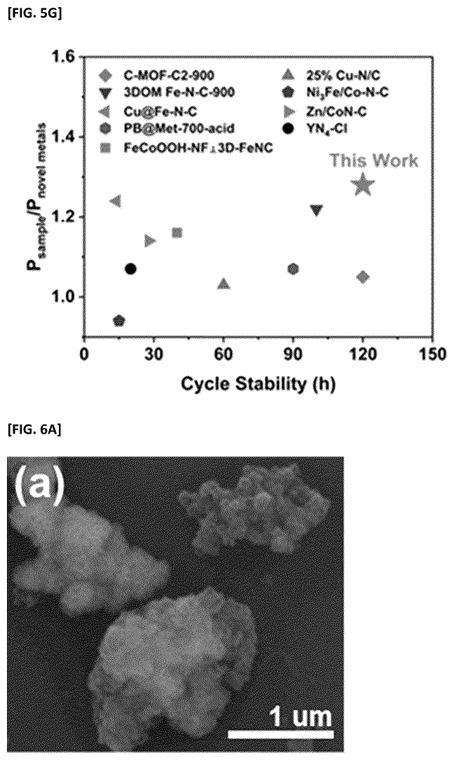

FIG. 5A to FIG. 5G reveal the performance characterizations of a ZAB cell using CMH. As a cathode for ZAB, CMH materials were loaded on carbon paper with a PTFE gas diffusion layer (GDL). A polished Zn foil was utilized as an anode, and 6 M KOH+0.2 M Zn(CH₃CO₂)₂ was used as an electrolyte. For the comparison, the novel metal (Pt/C+RuO₂) catalyst (mass ratio=1:1) was also utilized. The assembled ZAB device displayed a high open-circuit voltage (OCV) of 1.43 V, which is identical to that integrated with the novel metal counterpart. It was observed to keep the OCV for 10 hours, proving exceptional electrochemical stability (FIG. 5A). Also, two ZABs were linked to lighten a series of light-emitting diodes (LEDs), as shown in FIG. 5B, demonstrating practical applicability. The charging-discharging polarization curves were also obtained. When compared with the Pt/C+RuO₂ catalyst, the ZAB with CMH performed better with reduced ORR voltage gaps at high current densities, confirming its outstanding performance. Besides, the power densities (FIG. 5C) were computed using the ORR polarization curves. The power density of the ZAB with CMH was 394.2 mW cm⁻², which is 1.28 times higher than that (308.9 mW cm⁻²) of the ZAB with Pt/C+RuO₂. The cycle stability of the ZAB with CMH was further examined under a continuous galvanostatic discharge-charge at a current density of 10 mA cm⁻² with a duration of 10 min each cycle (FIG. 5D). The ZAB with CMH demonstrated 600 cycles, corresponding to continuous operation for 100 hours with no voltage degradation. The ZAB with Pt/C+RuO₂ was displayed to have an inferior cycle life of 64 cycles, implying that the ZAB with CMH leads to greater long-term durability, thereby providing a way to overcome the limitations of the novel metal catalysts. In addition, the rate performance of the ZAB with CMH was monitored, as revealed in FIG. 5E. The discharge potentials of the device were measured at the current densities of 1, 5, 10, 50, and 100 mA cm⁻², and then returned gradually back to 1 mA cm⁻². The measured discharge potentials were stable. The results confirmed excellent ORR stability and reversibility. Moreover, the specific capacities and energy densities were calculated by measuring the consumed mass of Zn during the electrochemical process. At a discharge current rate of 10 mA cm⁻², the ZAB with CMH exhibited a high capacity of 803 mAh g⁻¹ as well as a high energy density of 879 Wh kg⁻¹. These correspond to 97.9% and 80.9% of the theoretical capacity and energy density values. However, the ZAB with Pt/C+RuO₂ was measured to deliver a lower capacity of 692 mAh g⁻¹ and a lower energy density of 844 Wh kg⁻¹ at the same discharge current density (FIG. 5F). Additionally, CMH was compared with previously reported electrocatalysts for ZABs (FIG. 5G). For a fair comparison, the relative power density ratios of prepared samples to precious metal catalysts under identical experimental conditions were calculated. CMH samples demonstrated excellent performance in terms of power density and cycle stability. As a result, these findings support the notion that CMH is a bifunctional ORR/OER electrocatalyst allowing superior ZAB performances and hence has significant promise as a contender for future ZAB systems.

### 3. Conclusion

we derive a CoO—Mn₃O₄ heterostructure (CMH) cathode material from an Mn-doped metal-organic framework (MOF). In comparison to a single isolated phase, the CMH is demonstrated to modulate electron distributions at its metal oxide interfaces which allow high catalytic performances for OER during charge and ORR during discharge. Additionally, assembling the ZAB in a full-cell configuration with CMH cathode and Zn anode electrode outperform the benchmark novel metal-based ZAB system. As a result, we believe that this research can be used to lay the groundwork for the rational design of high-performance ZABs.

we present a bifunctional OER/ORR/OER electrocatalyst developed from a Mn-doped heterometallic metal-organic framework (Mn-doped MOF) that exhibits excellent ORR/OER activities in ZABs. In addition, after adding additional Mn and Co precursors to an Mn-doped MOF, a solvothermal treatment is performed. As a result of acidic etching and coprecipitation during the synthetic process, a Mn/Co layered double hydroxide (Co/Mn LDH) is shown to be produced. After that, it is demonstrated that the facile pyrolysis of a Mn/Co LDH results in the formation of a CoO-Mn₃O₄ heterostructure (CMH) structure between rock salt-type CoO and tetragonal spinel-type Mn₃O₄ nanoparticles. Mn₃O₄ grains are shown to grow along the edges of CoO, with the possibility of entropic mixing, thereby allowing the heterogeneous connections of Co and Mn oxide species to form, which aids in preventing bulk crystal formation even during high-temperature annealing. Moreover, the CMH cathode material is demonstrated to enable high performances with a higher ORR current density than that of the Pt/C catalyst as well as an excellent OER Tafel slope and overpotential exceeding those of the RuO₂ catalyst. The atomic structures of the CMH are also deduced using the global optimization of a genetic algorithm combined with a machine learning force field. Furthermore, the first-principles electronic structure calculations are used to discover charge transfer mechanisms and active sites for OER and ORR in the identified heterostructure. Additionally, we assemble CMH cathode and Zn metal anode into a ZAB full-cell configuration to realize high electrochemical performance, as demonstrated by a about 5.5-fold higher energy density of 879 Wh kg⁻¹ exceeding those of commercial lithium-ion batteries (LIBs), a high-discharge power density of 394.2 mW cm⁻², and cycle stability with negligible voltage decay, thereby superior to the ZAB assembled with the benchmark Pt/C+RuO₂ electrocatalyst.

To summarize, the Mn-doped MOF-derived CoO and Mn₃O₄ heterostructure has been developed as a bifunctional electrocatalyst for the ZAB cathode. Each phase cooperatively contributed to OER and ORR performances. In particular, CMH exhibited great ORR activity and durability, as well as excellent OER performances including a high current density outperforming that of the precious RuO₂ OER catalyst. Furthermore, the ZAB full cell with CMH displayed a 1.28-fold higher peak power density (394.2 mW cm⁻²) as well as a high energy density (879 Wh kg⁻¹) with a high specific capacity (803 mAh g⁻¹), thereby superior to those of the ZAB with Pt/C. In addition, the CMH-based ZAB attained a longer cycle life of 600 cycles outperforming even those of the benchmarking Pt/C+RuO₂-based ZAB. Consequently, this invention will pave the way to realize efficient electrocatalysts affording high energy density, high power density, and cycle stability in ZABs.

It would be understood by a person with ordinary skill in the art that various changes and modifications may be made based on the above description without changing technical conception and essential features of the present disclosure. Thus, it is clear that the above-described embodiments are illustrative in all aspects and do not limit the present disclosure.

The scope of the present disclosure is defined by the following claims. It shall be understood that all modifications and embodiments conceived from the meaning and scope of the claims and their equivalents are included in the scope of the present disclosure.

We claim:

1. An air electrode for a metal-air battery, comprising:
a cobalt-manganese heterostructure which contains a cobalt oxide and a manganese oxide,
wherein an interface between the cobalt oxide and the manganese oxide contains an oxygen defect.

2. The air electrode of claim 1,
wherein the cobalt-manganese heterostructure is flower-like.

3. The air electrode of claim 1,
wherein the cobalt oxide includes CoO.

4. The air electrode of claim 1,
wherein the manganese oxide includes Mn₃O₄.

5. The air electrode of claim 1,
wherein the cobalt-manganese heterostructure has a particle size of 10 nm to 500 nm.

6. The air electrode of claim 1,
wherein the cobalt-manganese heterostructure exhibits bifunctional catalytic activity for OER (oxygen evolution reaction) and ORR (oxygen reduction reaction).

7. The air electrode of claim 1,
wherein the cobalt-manganese heterostructure has a current density value of 500 mA cm⁻² or more.

8. The air electrode of claim 1,
wherein the cobalt-manganese heterostructure has an overpotential value of 300 mV or less at a current density of 10 mA cm⁻².

9. The air electrode of claim 1,
wherein a lattice oxygen oxidation mechanism (LOM) of the cobalt-manganese heterostructure is activated by the oxygen defect.

10. The air electrode of claim 1, further comprising:
a substrate.

11. A metal-air battery, comprising:
the air electrode according to claim 1, an anode containing a metal; and an electrolyte.

12. The metal-air battery of claim 11,
wherein the metal-air battery has an energy density value of 875 Wh kg⁻¹ or more at a discharge current rate of 10 mA cm⁻².

13. The metal-air battery of claim 11,
wherein the metal-air battery has a metal utilization rate of 97% or more.

14. The metal-air battery of claim 11,
wherein the metal-air battery has a cycle life of 600 cycles or more.

15. The metal-air battery of claim 11,
Wherein the metal-air battery is a zinc-air battery, an aluminum-air battery, a magnesium-air battery, or a lithium-air battery.

16. A method of preparing a cobalt-manganese heterostructure, comprising:
obtaining a metal-organic framework;
mixing the metal-organic framework, a cobalt precursor, a manganese precursor, and a solvent, and
performing a solvothermal reaction to obtain a cobalt-manganese layered double hydroxide; and
performing a thermal treatment of the cobalt-manganese layered double hydroxide to obtain the cobalt-manganese heterostructure.

17. The method of claim 16,
wherein the metal-organic framework includes Mn-doped ZIF-67.

18. The method of claim 16,
Wherein the solvothermal reaction is performed at 100° C. to 150° C. for 10 hours to 20 hours.

19. The method of claim 16,
wherein the thermal treatment of the cobalt-manganese layered double hydroxide is performed at 700° C. to 800° C. for 1 hour to 10 hours.
